(19) United States
(12) Patent Application Publication
(10) Pub. No.: US 2024/0168614 A1
(43) Pub. Date: May 23, 2024

(54) CONTENT EDITING METHOD AND DEVICE USING SHARED CONTENT

(71) Applicant: KINEMASTER CORPORATION, Seoul (KR)

(72) Inventors: Ha Young RYU, Seoul (KR); Jae Won CHUNG, Seoul (KR)

(21) Appl. No.: 18/551,181

(22) PCT Filed: Mar. 24, 2022
(86) PCT No.: PCT/KR2022/004135

§ 371 Date: Sep. 18, 2023

(30) Foreign Application Priority Data
Mar. 24, 2021 (KR) 10-2021-0037745
Mar. 24, 2022 (KR) 10-2022-0036465

(51) Int. Cl. G06F 3/0484; G11B 27/02

(52) U.S. Cl. CPC G06F 3/0484; G11B 27/02

(57) ABSTRACT

Disclosed herein a content editing method and device using shared content. The content editing method includes: presenting at least one reference content having a reference relationship with content; in response to user selection of the reference content, providing a reference entity including at least one of the reference content or a reference project including a reference editing element applied to the selected reference content; and editing user content using the reference entity.

### TECHNICAL FIELD

The present disclosure relates to a content editing method and device using a shared content project, and more particularly to a content editing method and device using shared content, which are capable of more easily editing a user's video by sharing at least one of content or a project including a content editing element of another user.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a liquid crystal screen and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing images or videos captured through the camera device are increasing.

Meanwhile, the edited video may be uploaded to a viewable video platform and social media. A video platform or the like may provide an interface indicating a liking for a video, or follow a user who created a video, so that the user can evaluate the video they have watched.

The above-described conventional video service only allows the user who has watched the video to passively express the level of liking for the video, and does not provide a way to actively utilize the editing technique of the video when the user creates or edits their video.

Recently, users of video platforms are not satisfied with watching other people's videos, and have a great desire to effectively edit their own videos to provide unique content. However, since there are not only a wide variety of elements in video editing, but also new editing effect techniques are being released, it is difficult for users to come up with effective editing elements when actually creating or editing videos. Therefore, there is a need for a service that creates and edits a video by referring to editing elements included in the video having a high level of liking.

### DISCLOSURE

### Technical Problem

An object of the present disclosure is to provide a content editing method and device using shared content, which are capable of more easily editing a user's video by sharing at least one of content or a project including a content editing element of another user.

The technical problems solved by the present disclosure are not limited to the above technical problems and other technical problems which are not described herein will be clearly understood by a person having ordinary skill in the technical field, to which the present disclosure belongs, from the following description.

### Technical Solution

According to the present disclosure, there is provided a content editing method using shared content, performed by a computing device including at least one processor. The content editing method including: presenting at least one reference content having a reference relationship with content; in response to user selection of the reference content, providing a reference entity including at least one of the reference content or a reference project including a reference editing element applied to the selected reference content; and editing user content using the reference entity.

According to the embodiment of the present disclosure in the method, the reference relationship can be a content history relationship established based on a series of preceding content directly or indirectly referred to in processing of the selected content and a series of succeeding content directly or indirectly referring to the selected content, and the reference relationship can be managed by structuring an association between the selected content and the series of preceding and succeeding content.

According to the embodiment of the present disclosure in the method, the editing the user content can include providing an editing element of the reference project on an editing element for editing of the user content, when the reference project is used.

According to the embodiment of the present disclosure in the method, the reference editing element can include at least one of a media object constituting the reference content or an editing tool configured to edit the reference content.

According to the embodiment of the present disclosure in the method, the editing the user content can include performing control to display the reference content in a predetermined area of an editing application processing the user content and view at least a part of the reference content by user manipulation, when the reference content is used.

According to the embodiment of the present disclosure in the method, the presenting the reference content can include outputting some of a plurality of reference content having a reference relationship with the content according to a user request or setting of the computing device.

According to the embodiment of the present disclosure in the method, the output reference content can include at least firstly created preceding content of the series of preceding content directly or indirectly referred to in processing of the content.

According to the embodiment of the present disclosure in the method, the output reference content can be selected based on preference information of the plurality of reference content, and the preference information can include at least one of preference of the reference content or preference of a user who created the reference content.

According to the embodiment of the present disclosure in the method, the output reference content can be selected based on a category of the editing element.

According to the embodiment of the present disclosure in the method, the content can be selected by user input from a shared content list provided by an editing application running in the computing device or an external service device connected to the computing device.

According to the embodiment of the present disclosure in the method, the reference relationship can be stored and managed by reference relationship information. Also, the method further can include: after the editing of the user content, uploading the user content; and updating the reference relationship information based on an entity of the user content.

According to another embodiment of the present disclosure, there is provided a computing device for editing content using shared content, the computing device including: a communication module; and a processor configured to perform transmission and reception with the communication module and to control the computing device. The processor is configured to: present at least one reference content a reference relationship with content; in response to user selection of the reference content, provide a reference entity including at least one of the reference content or a reference project including a reference editing element applied to the selected reference content; and edit user content using the reference entity.

### Effects of Invention

According to the present disclosure, it is possible to provide a content editing method and device using shared content, which are capable of more easily editing a user's video by sharing at least one of content or a project including a content editing element of another user.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control device according to various embodiments of the present disclosure.

FIGS. 5A to 5E are diagrams illustrating a clip editing UI provided by a video editing UI according to various embodiments of the present disclosure.

FIG. 6 is a flowchart illustrating a content editing method using shared content according to an embodiment of the present disclosure.

FIG. 7 is a diagram illustrating an initial screen provided by a content editing application.

FIGS. 8a and 8b are diagrams illustrating examples of outputting a reference video while a content video is structured and managed according to a reference relationship.

FIG. 9 is a diagram illustrating a criterion for selecting a reference video included in a reference video list.

FIGS. 10A to 10D are diagrams illustrating a process of editing user content by a content editing method according to an embodiment of the present disclosure.

### MODE FOR INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an embodiment could be termed a second element in another embodiment, and, similarly, a second element in an embodiment could be termed a first element in another embodiment, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these embodiments are provided so that this disclosure will be complete and will fully convey the scope of the invention to those skilled in the art.

Hereinafter, embodiments of the present disclosure will be described with reference to the accompanying drawings.

Various embodiments of the present disclosure may be implemented in an electronic device having a communication module, a memory, a display unit and a processor, and a video editing device according to an embodiment of the present disclosure may be implemented by an electronic device having an editing application installed therein. According to the present disclosure, an electronic device may be a type of computing device according to the present disclosure. For convenience of description, in the present disclosure, an editing application is described as being a video editing application, for example. In addition, the video editing device may be implemented by an electronic device having an image processing unit capable of processing a video and subtitle data and a controller.

Preferably, an electronic device to which various embodiments of the present disclosure are applied means a portable electronic device. The electronic device may be a user device, and the user device may be various types of devices such as, for example, a smartphone, a tablet PC, a laptop, and a desktop.

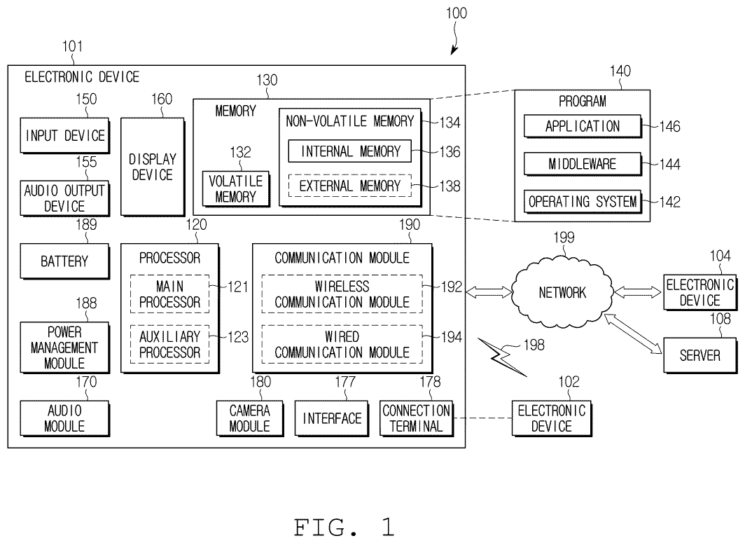

FIG. 1 is a block diagram illustrating an electronic device 101 in a network environment 100, as a diagram illustrating an electronic device to which various embodiments of the present disclosure are applied. The electronic device 101 may be referred to as a computing device, and the electronic device 101 may have a built-in video editing application or an application downloaded from the outside and installed therein.

Referring to FIG. 1, in the network environment 100, the electronic device 101 communicates with an electronic device through a first network 198 (e.g., short-range wireless communication), or communicate with an electronic device 104 or a server 108 through a second network 199 (e.g., a long-distance wireless communication). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, and an interface 177, a camera module 180, a power management module 188, a battery 189, a communication module 190 for transmitting and receiving data through networks 198 and 199, and the like. In another embodiment, in the electronic device 101, at least one of these components (e.g., the display device 160 or the camera module 180) may be omitted or another component may be added.

The processor 120 may, for example, drive software (e.g., program 140) to control at least one other component (e.g., hardware or software component) of the electronic device 101 connected to the processor 120 and perform various data processing and calculations. The processor 120 may load and process commands or data received from another component (e.g., the communication module 190) into a volatile memory 132, and store resultant data in a non-volatile memory 134. According to an embodiment, the processor 120 may include a main processor 121 (e.g., a central processing unit or an application processor) and an auxiliary processor 123 that operates independently of the main processor 121. For example, the auxiliary processor 123 may be additionally or alternatively mounted on the main processor 121 to use less power than the main processor 121. As another example, the auxiliary processor 123 may include an auxiliary processor 123 (e.g., a graphic processing unit, an image signal processor, a sensor hub processor, or a communication processor) specialized for a designated function. Here, the auxiliary processor 123 may be operated separately from or embedded in the main processor 121.

In this case, the auxiliary processor 123 may, for example, control at least some of functions or states related to at least one (e.g., the display device 160 or the communication module 190) of the components of the electronic device 101 in place of the main processor 121, while the main processor 121 is in an inactive (e.g., sleep) state. As another example, while the main processor 121 is in an active (e.g., application execution) state, the auxiliary processor 123, along with the main processor 121, may control at least some of functions or states related to at least components of the electronic device 101.

According to an embodiment, the auxiliary processor 123 (e.g., an image signal processor or a communication processor) may be implemented as a part of another functionally related component (e.g., the camera module 180 or the communication module 190). The memory 130 may store various data, for example, software (e.g., program 140), used by at least one component of the electronic device 101 (e.g., the processor 120) and input data or output data for commands related thereto. The memory 130 may include a volatile memory 132 or a non-volatile memory 134.

The program 140 is software stored in the memory 130, and may include, for example, an operating system 142, middleware 144, or an application 146. The application 146 may include a plurality of software for various functions, and may have a content editing application according to the present disclosure. The editing application is executed by the processor 140 and may be software that creates a new video or selects and edits an existing video.

The input device 150 is a device for receiving a command or data to be used in a component (e.g., the processor 120) of the electronic device 101 from the outside (e.g., a user) of the electronic device 101, and may include, for example, a microphone, a mouse or a keyboard.

The audio output device 155 may be a device for outputting a sound signal to the outside of the electronic device 101. For example, the audio output device 155 may include a speaker used for general purposes such as playing multimedia or recording, and a receiver used exclusively for receiving calls. According to one embodiment, the receiver may be formed integrally with or separately from the speaker.

The display device 160 may be a device for visually providing information to the user of the electronic device 101. The display device 160 may include, for example, a display, a hologram device, or a projector and a control circuit for controlling the device. According to an embodiment, the display device 160 may include a touch circuitry or a pressure sensor capable of measuring the strength of a touch pressure. The display device 160 may detect the coordinates of a touch input area, the number of touch input areas, a touch input gesture, etc. based on the touch circuitry or the pressure sensor, and transmit the detected result to the main processor 121 or the auxiliary processor 123.

The audio module 170 may convert bidirectionally sound and electrical signals. According to an embodiment, the audio module 170 may obtain sound through the input device 150 or output sound through an external electronic device (e.g., an electronic device 102 (e.g., speaker or headphone)) connected to the electronic device 101 by wire or wirelessly.

The interface 177 may support a designated protocol capable of connecting to an external electronic device (e.g., the electronic device 102) by wired or wirelessly. According to one embodiment, the interface 177 may include a high definition multimedia interface (HDMI), a universal serial bus (USB) interface, an SD card interface, or an audio interface.

A connection terminal 178 is a connector capable of physically connecting the electronic device 101 and the external electronic device (e.g., the electronic device 102), for example, an HDMI connector, a USB connector, an SD card connector, or an audio connector (e.g., headphone connector).

The camera module 180 may capture still images and moving images. According to one embodiment, the camera module 180 may include one or more lenses, image sensors, image signal processors, or flashes.

The power management module 188 is a module for managing power supplied to the electronic device 101, and may be configured as at least a part of a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may support establishment of a wired or wireless communication channel between the electronic device 101 and the external electronic device (e.g., the electronic device 102, the electronic device 104, or the server 108) and performance of data communication through the established communication channel. The communication module 190 may include one or more communication processors that support wired communication or wireless communication that are operated independently of the processor 120 (e.g., an application processor). According to an embodiment, the communication module 190 includes a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and, using a corresponding communication module among them, may communicate with the external electronic device through a first network 198 (e.g., a short-range communication network such as Bluetooth, Bluetooth low energy (BLE), Wi-Fi direct, or infrared data association (IrDA)) or a second network 199 (e.g., a long-distance network such as a cellular network, the Internet, or a computer network (e.g., LAN or WAN)). The above-described various types of the communication modules 190 may be implemented as a single chip or may be implemented as separate chips.

Some of the above components may be connected to each other through a communication method between peripheral devices (e.g., a bus, GPIO (general purpose input/output), SPI (serial peripheral interface), or MIPI (mobile industry processor interface)) to exchange signals (e.g. commands or data) with each other.

According to an embodiment, commands or data may be transmitted or received between the electronic device 101 and the external electronic device 104 through the server 108 connected to the second network 199. Each of the electronic devices 102 and 104 may be the same as or different from the electronic device 101. According to an embodiment, at least some of the operations executed in the electronic device 101 may be executed in another or a plurality of external electronic devices. According to an embodiment, when the electronic device 101 needs to perform a specific function or service automatically or upon request, the electronic device 101 may request at least some functions associated with the function or service from the external electronic device instead of or additional to executing the function or service by itself. The external electronic device, which has received the request, may execute the requested function or additional function and deliver the result to the electronic device 101. The electronic device 101 may provide the requested function or service by processing the received result without change or additionally. To this end, for example, cloud computing, distributed computing, or client-server computing technology may be used.

The server 108 may transmit a video editing application according to the request of the electronic device 101 and control the electronic device 101 to implement the application. When the application is running, the server 106 exchanges data with the electronic device 101 to support the electronic device 101, thereby performing the content editing method according to the present disclosure. In this regard, server 106 may be a type of computing device according to the present disclosure.

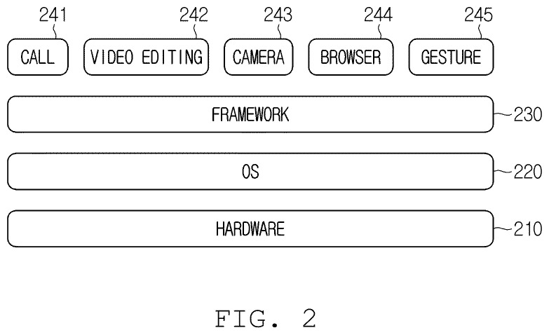

FIG. 2 is a diagram for explaining a system hierarchy structure of an electronic device to which various embodiments of the present disclosure are applied.

Referring to FIG. 2, an electronic device 200 may include a hardware layer 210 corresponding to the electronic device 100 of FIG. 1 described above, and an operating system (OS) layer 220 that manages the hardware layer 210 as a higher layer of the hardware layer 210, a framework layer 230 as a higher layer of the OS layer 220, and an application layer 240.

The OS layer 220 controls overall operations of the hardware layer 210 and performs a function of managing the hardware layer 210. That is, the OS layer 220 is in charge of basic functions such as hardware management, memory, and security. The OS layer 220 may include drivers for operating or driving hardware devices included in the electronic device, such as a display driver for driving a display device, a camera driver for driving a camera module, and an audio driver for driving an audio module. In addition, the OS layer 220 may include a library and a runtime that developers may access.

The framework layer 230 exists as a higher layer of the OS layer 220, and the framework layer 230 serves to connect the application layer 240 and the OS layer 220. That is, the framework layer 230 includes a location manager, a notification manager, and a frame buffer for displaying an image on the display unit.

The application layer 240 implementing various functions of the electronic device 100 is located above the framework layer 230. For example, the application layer 240 may include various application programs such as a call application 241, a video editing application 242, a camera application 243, a browser application 244, and a gesture application 245.

Furthermore, the OS layer 220 may provide a menu or UI capable of adding or deleting at least one application or application program included in the application layer 240, and through this, at least one application or application program included in the application layer 240 may be added or deleted by the user. For example, as described above, the electronic device 100 of FIG. 1 may be connected to the other electronic devices 102 and 104 or the server 108 through communication, and may receive data (that is, at least one application or application program) provided from the other electronic devices 102 and 104 or the server 108 by a user request and store it in the memory. At this time, at least one application or application program stored in the memory may be configured and operated in the application layer 240. In addition, at least one application or application program may be selected by the user using the menu or UI provided by the OS layer 220, and the selected at least one application or application program may be deleted.

Meanwhile, when a user control command input through the application layer 240 is input to the electronic device 100, it may be transferred from the application layer 240 to the hardware layer 210 to execute a specific application corresponding to the input control command, and the result may be displayed on the display device 160.

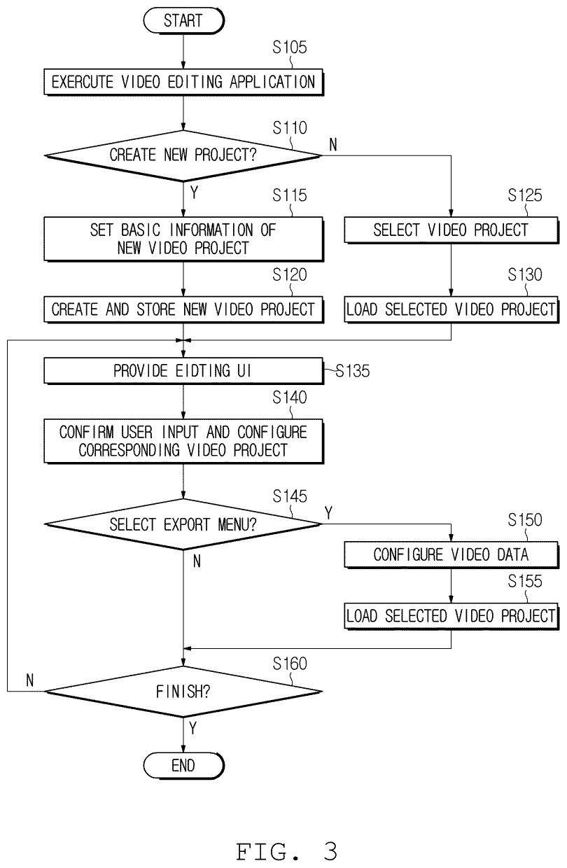

FIG. 3 is a flowchart illustrating a video editing method to which various embodiments of the present disclosure are applied.

Referring to FIG. 3, first, the video editing method may be operated by the above-described electronic device (or computing device), and the operation may be initiated as a video editing application is selected and executed by user input (S105).

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, the process may proceed to step S115, and when the video project selection menu (or UI) is selected, the process may proceed to step S125 (S110).

In step S115, the electronic device may provide a menu (or UI) for setting basic information of a new video project, and set and apply the basic information input through the menu (or UI) to the new video project. For example, the basic information may include an aspect ratio of the new video project. Based on this, the electronic device may provide a menu (or UI) capable of selecting an aspect ratio such as 16:9, 9:16, 1:1, etc., and an aspect ratio input through the menu (or UI) may be set and applied to the new video project.

Thereafter, the electronic device may create a new video project by reflecting the basic information set in step S115, and store the created new video project in a storage medium (S120).

Although the aspect ratio is exemplified as basic information in one embodiment of the present disclosure, the present disclosure is not limited thereto, and may be variously changed by a person having ordinary knowledge in the technical field of the present disclosure. For example, the electronic device may provide a menu (or UI) capable of setting at least one of automatic control of a master volume, the size of the master volume, audio fade-in default setting, audio fade-out default settings, video fade-in default settings, video fade-out default settings, default settings of an image clip, default settings of a layer length or pan & zoom default settings of the image clip, and a value input through the menu (or UI) may be set as the basic information of the new video project.

As another example, the electronic device may automatically set the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip to predetermined values. In addition, the electronic device may provide a setting menu (or UI), receive control values of the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip through the setting menu (or UI), and set the above-described default information according to the received values.

Meanwhile, in step S115, the electronic device may provide a project list including video projects stored in a storage medium and provide an environment in which at least one video project included in the project list may be selected. Through the above-described environment, the user may select at least one video project included in the project list, and the electronic device may load the at least one video project selected by the user (S130).

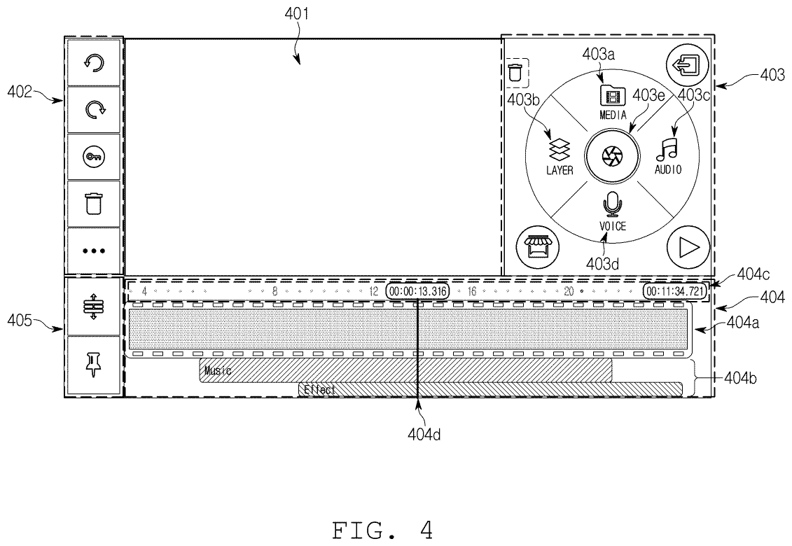

In step S135, the electronic device may provide an editing UI. The editing UI may include a video display window 401, a media setting window 402, a media input window 403, a clip display window 404, a clip setting window 405, and the like, as shown in FIG. 4. In the editing UI, the video display window, the media setting window, and the media input window may be displayed on an upper portion of the display, and the clip display window and the clip setting window may be displayed on a lower portion of the display.

The media setting window may include an export menu, a capture menu, a setting menu, and the like, and the export menu, the capture menu, and the setting menu may be provided in the form of icons or text capable of recognizing the corresponding menu.

The media input window may include a media input menu 403a, a layer input menu 403b, an audio input menu 403c, a voice input menu 403d, a shooting menu 403e, and the like, and the media input menu 403a, the layer input menu 403b, the audio input menu 403c, the voice input menu 403d, and the shooting menu 403e may be provided in the form of icons or text capable of recognizing the corresponding menu. Also, each menu may include a sub-menu, and as each menu is selected, the electronic device may compose and display a sub-menu corresponding thereto.

For example, the media input menu 403a may be connected to the media selection window as a sub-menu, and the media selection window may provide an environment capable of selecting media stored in a storage medium. Media selected through the media selection window may be inserted and displayed in the clip display window. The electronic device may check the type of media selected through the media selection window, set the clip time of the media in consideration of the checked type of the media, insert and display it in the clip display window. Here, the type of media may include images, videos, and the like. If the type of media is an image, the electronic device may check a default length setting value of the image clip and set an image clip time according to the default length setting value of the image clip. In addition, if the type of media is a video, the electronic device may set the time of the video clip according to the length of the corresponding media.

As a sub-menu of the layer input menu 403b, a media input menu, an effect input menu, an overlay input menu, a text input menu, a media input menu, and a drawing input menu may be included.

The media input menu may be configured in the same way as the aforementioned media input menu.

The effect input menu may provide an environment in which blur effect, mosaic effect, noise effect, sandstorm effect, melting point effect, crystal effect, star filter effect, display board effect, haze effect, fisheye lens effect, magnifying lens effect, flower twist effect, night vision effect, sketch effect, etc. may be selected. An effect selected through the effect input menu may be inserted and displayed in the clip display window. At this time, the electronic device may check the default setting value of the layer length and set the effect clip time according to the default setting value of the layer length.

The overlay input menu may provide an environment in which stickers and icons of various shapes or shapes may be selected. The stickers, icons, etc. selected through the overlay input menu may be inserted and displayed in the clip display window. At this time, the electronic device may check the default setting value of the layer length and set the clip times of stickers, icons, etc. according to the default setting value of the layer length.

The text input menu may provide an environment in which text may be input, for example, a Qwerty keyboard. The text input through the text input menu may be inserted and displayed in the clip display window. At this time, the electronic device may check the default setting value of the layer length and set the text clip time according to the default setting value of the layer length.

The drawing input menu may be configured to provide a drawing area in the image display window and to display a drawing object in a touch input area in the image display window. The handwriting input menu may include a drawing tool selection menu for selecting a drawing tool, a color selection menu for selecting a drawing color, a thickness setting menu for setting the thickness of a drawing object, a partial deletion menu for deleting a created drawing object, and a delete-all menu for deleting all drawn objects as sub-menus. In addition, when the handwriting input menu is selected, the electronic device may check the default setting value of the layer length and set the drawing object clip time according to the default setting value of the layer length.

The audio input menu 403c may be connected to the audio selection window as a sub-menu, and the audio selection window may provide an environment in which an audio file stored in a storage medium may be selected. An audio file selected through the audio selection window may be inserted and displayed in the clip display window.

The voice input menu 403d may be a menu for recording sound input through a microphone. When the voice input menu is selected by the user, the electronic device may activate the microphone provided in the device to detect a voice signal input through the microphone. In addition, the electronic device may display a recording start button, and when the recording start button is input, recording of the voice signal may be started. Furthermore, the electronic device may visualize and display the voice signal input through the microphone. For example, the electronic device may check amplitude or frequency characteristics of the voice signal and display the checked characteristics in the form of a level meter or a graph.

The shooting menu 403e may be a menu for capturing an image or video input through a camera module included in the electronic device. The shooting menu 403e may be displayed through an icon visualizing a camera device. The shooting menu 403e may include an image/video shooting selection menu for selecting a camera for capturing an image or a camcorder for capturing a video as a sub-menu thereof. Based on this, when the shooting menu 403e is selected by the user, the electronic device may display an image/video shooting selection menu. In addition, the electronic device may activate an image capturing mode or a video capturing mode of the camera module according to selection through the image/video capturing selection menu.

The clip display window 404 may include at least one clip line displaying a clip corresponding to media, effect, overlay, text, drawing, audio, voice signal, etc. input through the media input window.

The clip line may include a main clip line 404a and a sub clip line 404b, and a clip line provided at the uppermost end of the clip display window is referred to as the main clip line 404a, and at least one clip line provided under the main clip line 404a may be referred to as the sub clip line 404b.

The electronic device may fix and display the main clip line 404a at the uppermost end of the clip display window, check drag input based on an area where the sub clip line 404b exists, and scroll the sub clip line 404b up and down according to a drag input direction.

Furthermore, when the drag input direction is checked as an upward direction, the electronic device may move and display the sub clip line 404b to an upper area, and when the drag input direction is checked as a downward direction, the electronic device may move and display the sub clip line 404b to a lower area. In addition, the electronic device may display the height of the main clip line 404a differently according to the movement of the sub clip line 404b. For example, when the sub clip line 404b moves upward, the height of the main clip line 404a may be decreased and displayed, and when the sub clip line 404b moves downward, the height of the main clip line 404a may be increased and displayed.

In particular, the clip display window may include a time display line 404c indicating the time of the video project and a play head 404d. The time display line 404c may be displayed above the main clip line 404a described above, and may include a scale or number in a predetermined unit. In addition, the play head 404d may be displayed as a line starting from the time display line 404c and vertically connected to the lower end of the clip display window, and may be displayed in a color (e.g., red) that can be easily recognized by the user.

Furthermore, the play head 404d may be provided in a fixed form in a predetermined area, and the objects included in the main clip line 404a and the sub clip line 404b provided in the clip display window and the time display line 404c may be configured to be movable in the left and right directions.

For example, when drag input is generated in the left and right directions in an area where the main clip line 404a, the sub clip line 404b, and the time display line 404c are located, the electronic device may move and display the objects included in the main clip line 404a and the sub clip line 404b and the time display line 404c in the left and right directions. In this case, the electronic device may be configured to display a frame or object corresponding to the play head 404d in the image display window. In addition, the electronic device may check a detailed time (e.g., in units of 1/1000 second) that the play head 404d touches, and display the checked detailed time together in the clip display window.

In addition, the electronic device may check whether a multi-touch has occurred in the clip display window, and if a multi-touch has occurred, a scale or number of a predetermined unit included in the time display line 404c may be changed and displayed in response to the multi-touch. For example, when input in which a multi-touch interval gradually decreases is confirmed, the electronic device may decrease the interval between scales or numbers. When input in which the multi-touch interval gradually increases is confirmed, the electronic device may increase and display the interval between scales or numbers.

The electronic device may configure the clip display window 404 so that a clip displayed on the clip line may be selected, and when a clip is selected, it may visualize and display that the corresponding clip has been selected. For example, when selection of a clip is detected, the electronic device may provide a clip selector to a boundary of the selected clip, and the clip selector may be displayed in a predetermined color, for example, yellow.

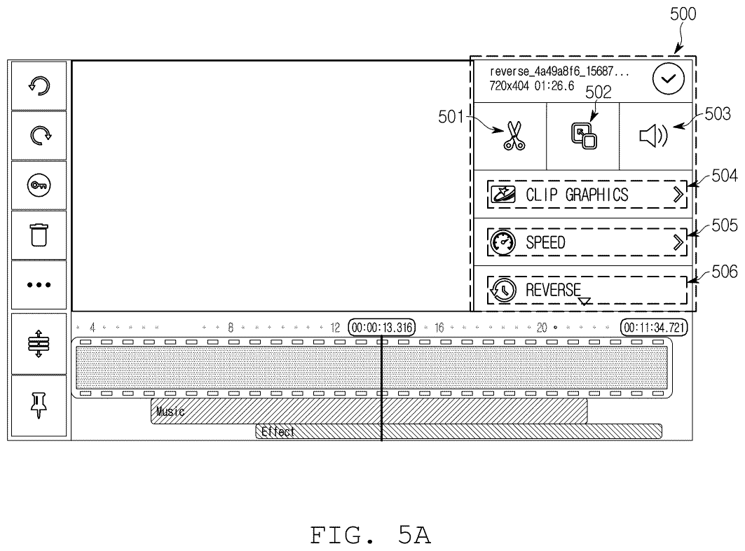

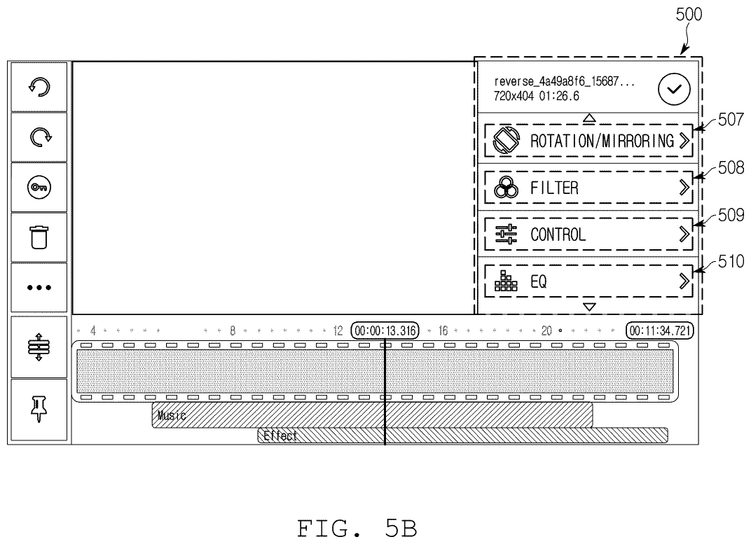

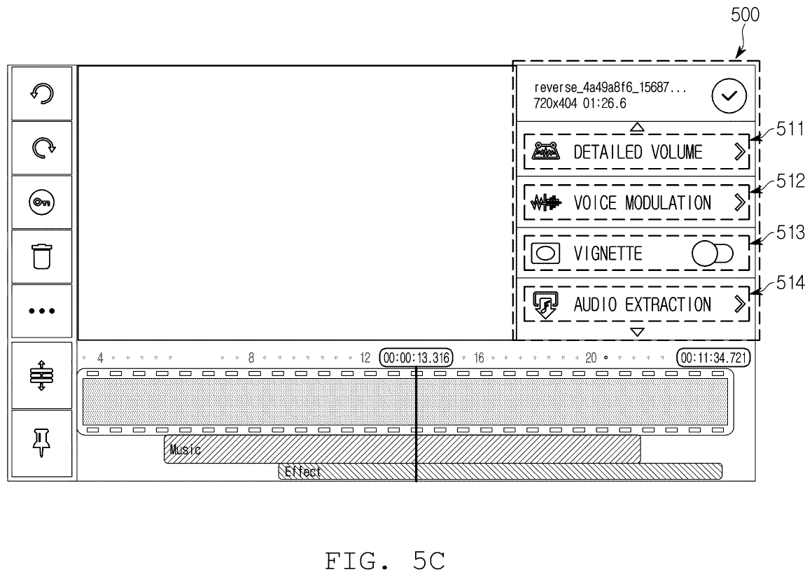

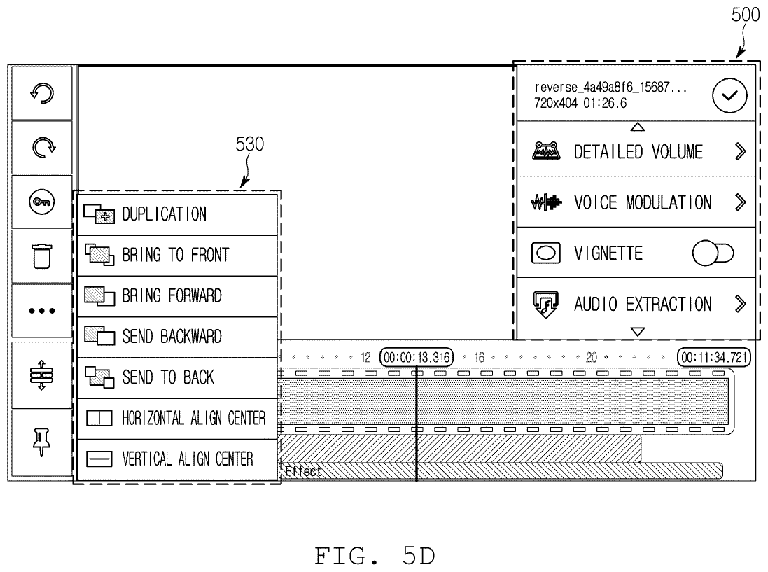

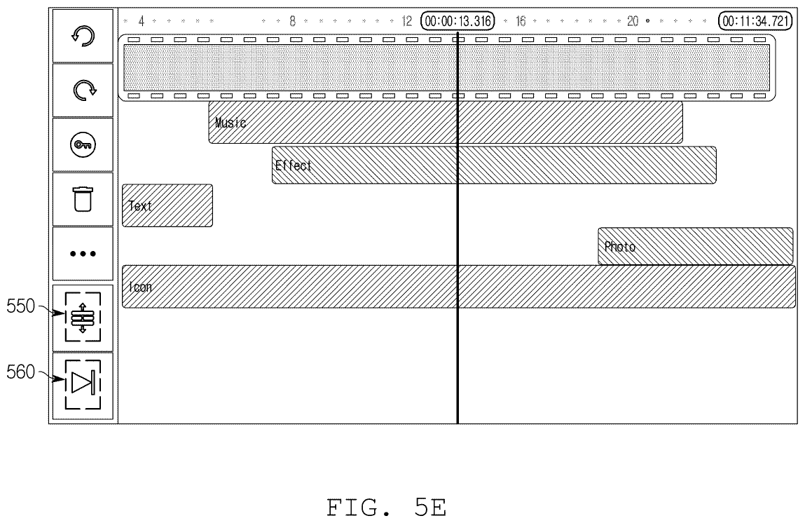

Preferably, when selection of a clip is detected, the electronic device may provide a clip editing UI capable of editing the selected clip. For example, the electronic device may display a clip editing UI in an area where the media input window 403 exists, as shown in FIGS. 5A to 5E. The clip editing UI may be set differently according to the type of the selected clip. Specifically, when the type of clip is a video clip, the electronic device may configure and provide a clip editing UI 500, by including a trim/split menu 501, a pan/zoom menu 502, an audio control menu 503, a clip graphic menu 504, and a speed control menu 505, a reverse control menu 506, a rotation/mirroring control menu 507, a filter menu 508, a brightness/contrast control menu 509, a voice EQ control menu 510, a detailed volume control menu 511, a voice modulation menu 512, a vignette control menu 513, an audio extraction menu 514, and the like.

The clip editing UI for each type of clip may be configured based on the structure of the video editing UI.

Additionally, the electronic device may further display a clip editing expansion UI 530 in an area where the media setting window exists. The clip editing expansion UI displayed in the area of the media setting window may also be set differently according to the type of the selected clip. For example, when the type of clip is a video clip, an image clip, an audio clip, or an audio signal clip, the electronic device may configure and provide the clip editing expansion UI 530 by including a clip deletion menu, a clip duplication menu, a clip layer duplication menu, and the like. If the type of clip is a video clip, image clip, audio clip, or audio signal clip, the electronic device may configure and provide the clip editing expansion UI 530 by including the clip deletion menu, the clip duplication menu, the clip layer duplication menu, and the like, and if it is an effect clip, text clip, overlay clip, or drawing clip, the electronic device may configure and provide the clip editing expansion UI by including a clip deletion menu, a clip duplication menu, a bring-to-front menu, a bring-forward menu, a send-backward menu, a send-to-back menu, a horizontal align center menu, a vertical align center menu and the like.

The clip setting window may include a clip enlargement display menu 550 and a clip movement control menu 560, as shown in FIG. 5e. When the clip display menu 550 is selected by the user, the electronic device may enlarge and display the clip display window to the entire area of the display. Also, when the clip movement control menu 560 is selected, the electronic device may move and display the clip according to the play head. Furthermore, the clip movement control menu 560 may include a start area movement menu or an end area movement menu, and it is preferable that the start area movement menu or end area movement menu may be adaptively displayed in consideration of the position of the play head touching the clip. For example, the electronic device basically provides the start area movement menu, and when a clip touches a starting position of the play head, the start area movement menu may be replaced with the end area movement menu and displayed.

In step S140, the electronic device may check user input input through the editing UI, configure a video project corresponding to the user input, and store the configured video project in a storage medium.

As described above, the editing UI is configured to include an export menu in the media setting window. When the export menu is selected by the user (Y in S145), the electronic device may configure video data by reflecting the information configured in the video project and store it in a storage medium (S150).

In addition, the electronic device 101 may upload the edited video and project to a shared video service-related device according to the request of a user, at the same time as or after the video data is stored through the export menu.

The structure of the editing UI provided by the device for controlling the video editing UI according to various embodiments of the present disclosure may be configured as follows.

First of all, the editing UI may basically include a video display window 401, a media setting window 402, a media input window 403, a clip display window 404, a clip setting window 405, and the like, as shown in FIG. 4. At least one clip selected through the media input window 403 may be displayed on the clip display window 404. In addition, as at least one clip 404a or 404b included in the clip display window 404 is selected, as shown in FIGS. 5a to 5d, clip editing menus 501, 502, . . . 514 may be provided in the area where the media input window 403 exists. At this time, the clip editing menus 501, 502, . . . 514 may be provided adaptively according to the structure of the editing UI for each clip type.

The video clip editing menu may include a trim/split menu, a pan/zoom menu, an audio control menu, a clip graphic menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, an audio extraction menu, and the like.

The trim/split menu may include a trim menu on the left of the play head, a trim menu on the right of the play head, a split menu on the play head, a still image split and insert menu, and the like, as sub-menus.

The audio control menu may include a master volume control bar, a sound effect volume control bar, an automatic volume ON/OFF menu, a left/right balance control bar, a pitch control bar, and the like, as sub-menus. In addition, the master volume control bar, the sound effect volume control bar, the left/right balance control bar, the pitch control bar, and the like may be set to support a detailed control UI, and the master volume control bar, the sound effect volume control bar, the left/right balance control bar, the pitch control bar and the like may be managed through the main editing UI. A UI set as the main editing UI may be configured to display a detailed control UI together. As another example, when touch input is generated for more than a predetermined time (e.g., 1 second) in an area where the main editing UI set to support the detailed control UI exists, the detailed control UI may be activated as a sub-menu.

The clip graphic menu may be configured to select at least one graphic to be inserted into the clip.

The speed control menu may include at least one predetermined speed control button (e.g., 1×, 4×, 8×), a speed control bar, a mute ON/OFF menu, a pitch maintenance ON/OFF menu, and the like. Also, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to the video.

The brightness/contrast/gamma control menu may include a brightness control bar, a contrast control bar, a gamma control bar and the like as sub-menus so as to control the brightness/contrast/gamma value of the video, and the brightness control bar, the contrast control bar, and the gamma control bar and the like may be managed as a main editing UI and set to support the detailed control UI.

The rotation/mirroring menu may include a horizontal mirroring menu, a vertical mirroring menu, a counterclockwise rotation menu, a clockwise rotation menu and the like as sub-menus, and the counterclockwise rotation menu and clockwise rotation menu may be managed as a main editing UI and set to support the detailed control UI.

The detailed volume control menu is a menu for controlling the volume of audio included in the video, and may include a control point addition menu, a control point deletion menu, a voice control bar and the like. The voice control bar may be managed as a main editing UI and set to support the detailed control UI.

The voice modulation control menu may be configured to select at least one voice modulation method to be applied to the video.

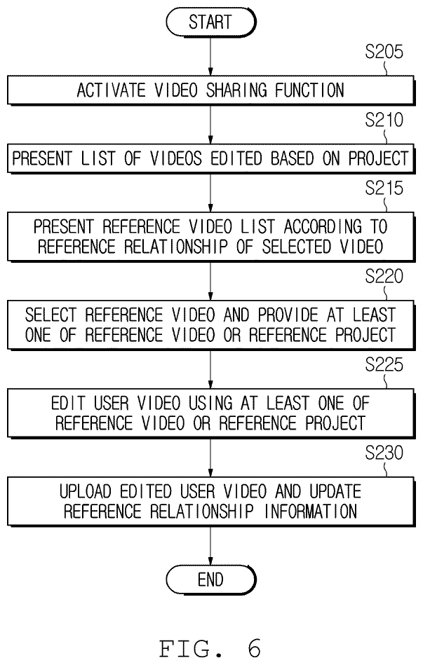

Meanwhile, the image clip editing menu may include a trim/split menu, a pan/zoom menu, a rotation/mirroring control menu, a clip graphic menu, a filter menu, a brightness/contrast/gamma control menu, a vignetting ON/OFF control menu, and the like, and these menus may be configured similarly to the control menu illustrated in FIG. 6a.

In addition, the effect clip editing menu may include an effect setting menu, a transparency control menu, a trim/split menu, a rotation/mirroring control menu, and the like, and the trim/split menu, the rotation/mirroring control menu and the like may be configured similarly to the video clip editing menu. In addition, the effect setting menu and the transparency control menu may include an effect setting bar and a transparency control bar, respectively, as sub-menus, and the effect setting bar and the transparency control bar may be managed as a main editing UI and set to support the detailed control UI.

The overlay clip editing menu may include an overlay color setting menu, a transparency control menu, a trim/split menu, a rotation/mirroring control menu, a blending type setting menu, and the like. The trim/split menu, the rotation/mirroring control menu and the like may be configured similarly to the video editing menu. Also, the transparency control menu may include a transparency control bar as a sub-menu, and the transparency control bar may be managed as a main editing UI and set to support the detailed control UI.

In addition, the text clip editing menu may include a text font setting menu, a text color setting menu, a trim/split menu, a transparency control menu, a rotation/mirroring control menu, a text alignment method setting menu, a shadow ON/OFF menu, a glow ON/OFF menu, an outline ON/OFF menu, a background color ON/OFF menu, a blending type setting menu, and the like, and the trim/split menu, the transparency control menu, the rotation/mirroring control menu, and the like may be configured similarly to the video clip editing menu. In addition, the shadow ON/OFF menu, the glow ON/OFF menu, the outline ON/OFF menu, and the background color ON/OFF menu may respectively include a color control bar (e.g., R/G/B control bar) for setting a color or a transparency control bar for controlling transparency as sub-menus, and the color control bar (e.g., R/G/B control bar) or the transparency control bar may be managed as a main editing UI and set to support the detailed control UI.

In addition, the drawing clip editing menu may include a transparency control menu, a trim/split menu, a rotation/mirroring control menu, a blending type setting menu, and the like, and the trim/split menu, the rotation/mirroring control menu and the like may be configured similarly to the overlay clip editing menu. Also, the transparency control menu may include a transparency control bar as a sub-menu, and the transparency control bar may be managed as a main editing UI and set to support the detailed control UI.

In addition, the audio clip editing menu may include an audio control menu, a voice EQ control menu, a detailed volume control menu, a voice modulation control menu, a ducking ON/OFF control menu, a repeat ON/OFF control menu, a trim/split menu, and the like. The audio control menu, the voice EQ control menu, the detailed volume control menu, the voice modulation control menu, the trim/split menu, and the like may be configured similarly to a video clip editing menu.

FIG. 6 is a flowchart illustrating a content editing method using shared content according to an embodiment of the present disclosure.

The embodiment according to FIG. 6 relates to a case in which the electronic device 101 accesses a content sharing menu provided in a video editing application according to a user request and obtains a reference entity related to reference content to be used to edit user content. As another example, the electronic device 101 may obtain a reference entity by creating a new project or selecting an existing project being edited and then accessing a content sharing menu provided in the project, according to a user request. The content sharing menu may be provided in an editing user interface that visually provides the project.

In the present disclosure, a project includes an edited video and information related to an editing element applied in a video creation or editing process, so that a user can check an editing element in a corresponding video. The project may be implemented visually through an editing user interface. The editing element may be provided through an editing user interface, for example, the video display window 401 and the clip display window 404 illustrated in FIG. 4.

In the present disclosure, for convenience of description, content is a video (hereinafter, used interchangeably with an image), and the electronic device 101 is the user device 101, for example.

First, as shown in FIG. 3, an operation may be initiated when a video editing application is executed by user input.

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, a user content editing process may be performed using a process similar to step S115. In addition, when the video project selection menu (or UI) is selected, the user content editing process may be performed using a process similar to step S125.

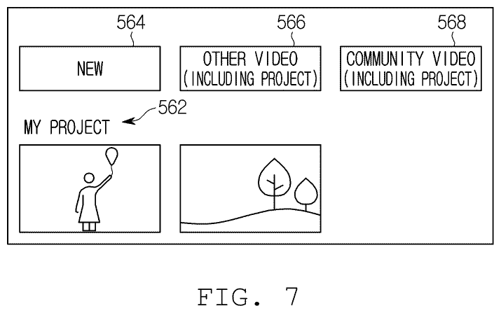

FIG. 7 is a diagram showing an initial screen provided by a content editing application.

A menu for creating a new image project may be provided, for example, through “New” 564. A menu for selecting a video project being edited by a user may be provided through, for example, “my project” 562.

In addition, the initial screen may additionally provide a video sharing menu accessible by the user so as to share videos and projects created or edited by the user and other users. The video sharing menu may be configured to include a list of shared videos, that is, a list of shared content, provided by the server 108 or an external service device connected to the electronic device 101 or a video editing application running on the electronic device 101. The external service device may be a server that manages external t sources. The external content source may be, for example, YouTube, VLOG, shortcut media, social media, a service, a third-party user device accepting content sharing, and a content sharing community serviced therefrom. The content sharing community may manage the video so as to include project-related information capable of verifying at least an editing element in the application, along with the video. In addition to this, when obtaining (e.g., downloading) the video from the application, the content sharing community may configure project-related information so that the editing element can be directly borrowed. The list of shared videos provided by the application may be transmitted from the server 108 supporting the application. The server 108 may manage project-related information having a function of inquiring and borrowing the editing element along with the video.

Referring to FIG. 7, a video sharing menu provided by a video editing application may be implemented as, for example, “other video” 566, and a video sharing menu related to an external service device may be provided as, for example, “community video” 568.

Referring to FIG. 6, the video editing application may activate the video sharing function provided on the initial screen according to the request of the user device 101 (S205).

For example, the video sharing function may be a video sharing menu (e.g., denoted by reference numerals 566 and 568) provided to the application or provided by an external service device. For convenience of description, in this disclosure, a video sharing menu of the server 108 related to the other video 566 will be described as an example. The user may inquire a shared video from the server 108 by selecting “other video” 566.

Next, the video sharing menu 566 may present a list of shared videos to the user device 101 (S210).

The list of shared videos includes at least one video, and each video may be managed in association with a project including an editing element. The list of videos may be managed by the server 108 supporting the application, and the server 108 may store all videos and projects. In another example, an external service device may store videos and projects, and the server 108 may store identification information for identifying videos and projects, access information for accessing corresponding content, and the like. The server 108 may receive and retain a summary image, for example, a thumbnail image, from the external service device. Accordingly, when the community video 568 is selected by the user device 101, the server 108 may provide a summary image from the list of videos. As will be described later, when the user device 101 requests a video belonging to the community video 568, the server 108 may receive the entire video and project from the external service device through the identification information and access information of the requested video and transmit it to the user device 101.

In the present disclosure, a video may be content to which an editing element is added through a video editing application installed in the user device 101 or another type of compatible editing application. The project created by the application may allow the user to check individual editing elements and to control addition, deletion, and change of the editing elements.

The video-related content and project will be described in more detail. The video-related content may include at least one of text, audio, image, or video as a media object. The content may be original content or modified content edited from original content by another user. A media object of content may include at least one of various editing elements exemplified in an effect input menu, an overlay input menu, and a drawing input menu.

A project (or project information, project file) used to create or edit video-related content may include at least one of an element related to a media object or an element related to an editing tool applied to the corresponding content as an editing element. Here, the editing element may be attribute data of the project, and the attribute data may be implemented in the form of meta data, for example.

Each element related to editing may be temporally or spatially arranged and combined, thereby creating content. The elements may be overlapped, arranged and combined in the depth direction in the same time and two-dimensional space, and in this case, depth information between the elements may be included. The arrangement and combination of the above elements may be referred to as a relationship between elements of advertising content in this specification.

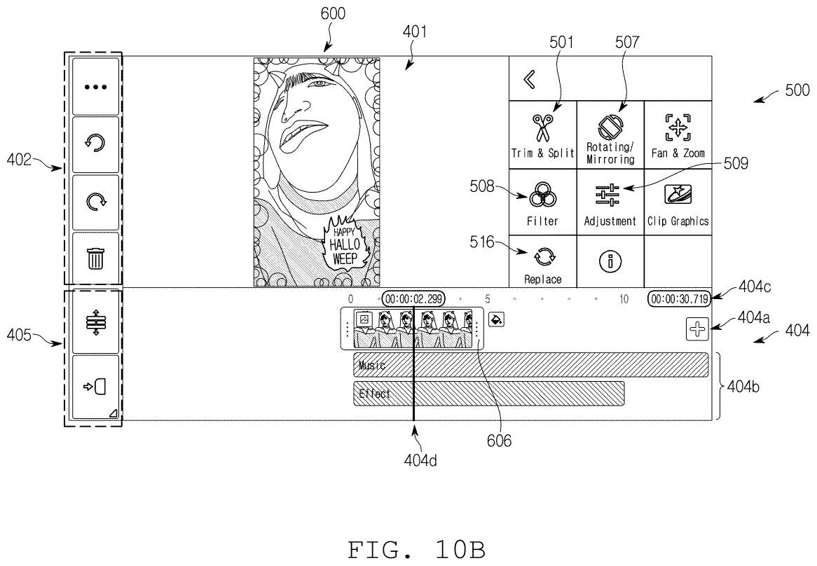

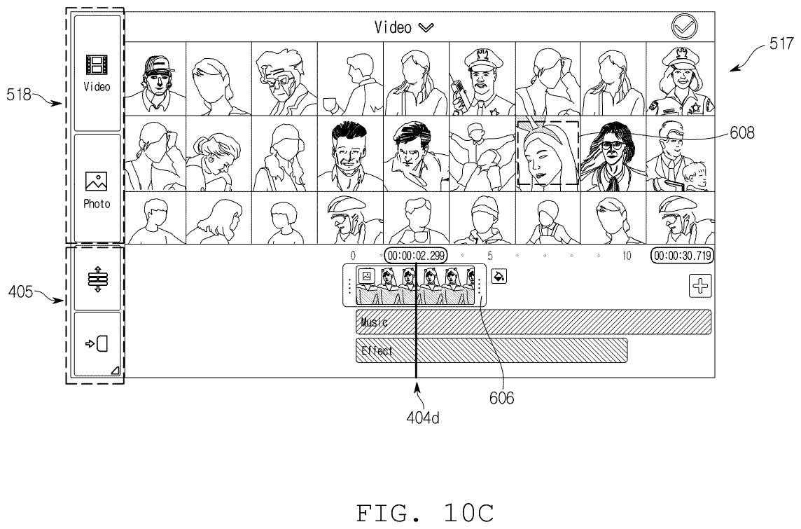

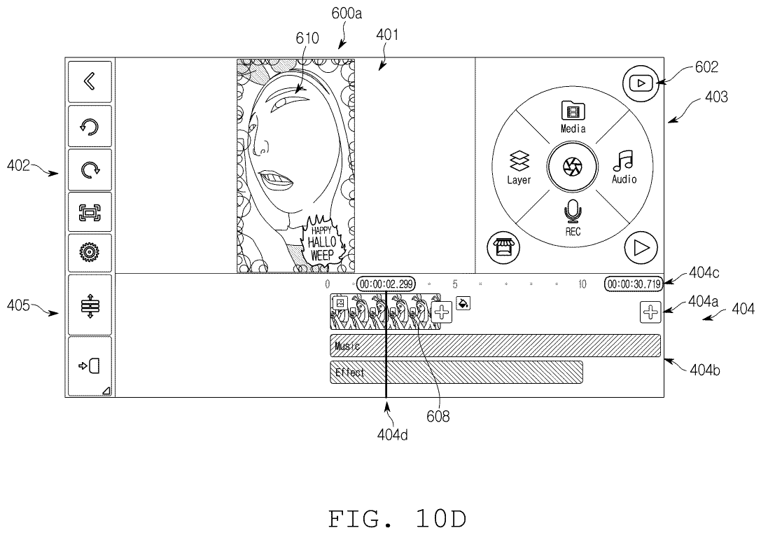

An element related to a media object may be attribute data designating at least a part of a video displayed in content. In addition, the element related to the media object may be attribute data designating at least one of music, sound, image frames, graphic icons, graphic stickers, background images, text, overlapped layers, and drawing objects constituting the content 600 (or reference content) in FIG. 10a. Also, the overlapped layer may be an overlay object overlapping a main video, for example, a sub video, an accessory icon, or a sticker. The drawing object may be an object that may be created in a drawing area where a touch is input to the video display window 401. The audio and voice may be a pre-stored audio file or a voice obtained from a microphone of an electronic device.

The element related to the editing tool may include an editing function for adding additional effects to media constituting the content 600 illustrated in FIG. 10a. For example, the editing tool is provided in the media input window 403 and the clip editing UI 500 and may be editing elements that give various additional effects to the media.

Regarding the additional effects, the expression method specified by the editing menus illustrated in FIGS. 5a to 5d may be applied to media such as video, image, text, and audio. The effects may be checked through the video display window 401, the clip display window 404 and the like. In addition to the expression methods provided by the editing menus of FIGS. 5a to 5d, the effects may also be implemented through an additional expression method menu provided in a video editing application not shown in the drawings.

Examples of the video and image effects may include, for example, blur effect, mosaic effect, noise effect, sandstorm effect, melting point effect, crystal effect, star filter effect, display board effect, haze effect, fisheye lens effect, magnifying lens effect, flower twist effect, night vision effect, a sketch effect, etc.

Next, the user device 101 may select a video from the list of shared videos, and the application may present at least one reference video having a reference relationship with the selected video, that is, a reference video list including reference content (S215).

The reference relationship may be a content history relationship established based on a series of preceding content that is directly or indirectly referred to in the processing of the selected video and a series of succeeding content that directly or indirectly refers to the selected content. The reference relationship may be managed by structuring associations between the selected content and the series of preceding and succeeding content. The reference relationship may be managed as, for example, reference relationship information stored by the server 108.

Specifically, the reference relationship may be data obtained by structuring the relationship between the preceding content referred to during video creation and editing and the succeeding content referring to the content. Here, the reference may mean that a succeeding user obtains the video and project of a preceding user from the video sharing menus 566 and 568 in order to edit their own video. Accordingly, the succeeding user may directly utilize the editing element of the project used by the preceding user, or may check the obtained project or video and use it as a reference in editing their own video without borrowing the editing element.

An example of directly using the editing element may include a case in which a project of a preceding user is directly loaded into the video display window 401 and the clip display window 404 in order for a succeeding user to edit their own video. The case where the editing element is not directly borrowed may be, for example, a case in which a succeeding user does not load the project of a preceding user into the video display window 401 and the clip display window 404 while editing their own video in a new or existing project. The application may control the user device 101, such that a window may be provided in a predetermined area separately from the video display window 401 and the clip display window 404 to view a preceding user's video or project through the separate window. When the succeeding user reflects the editing element included in the video to their video, the application may check whether the editing element of the succeeding user is included in the edited video of the preceding user. As a result of checking, if the editing element is included, the application may set a reference relationship between the preceding and succeeding videos and notify the server 108 of it.

Therefore, if the succeeding user obtains a reference entity including at least one of the video or project of a preceding user using a downloading or streaming method and it is confirmed that the editing element of the preceding user is reflected in the video of the succeeding user, the reference relationship may be satisfied.

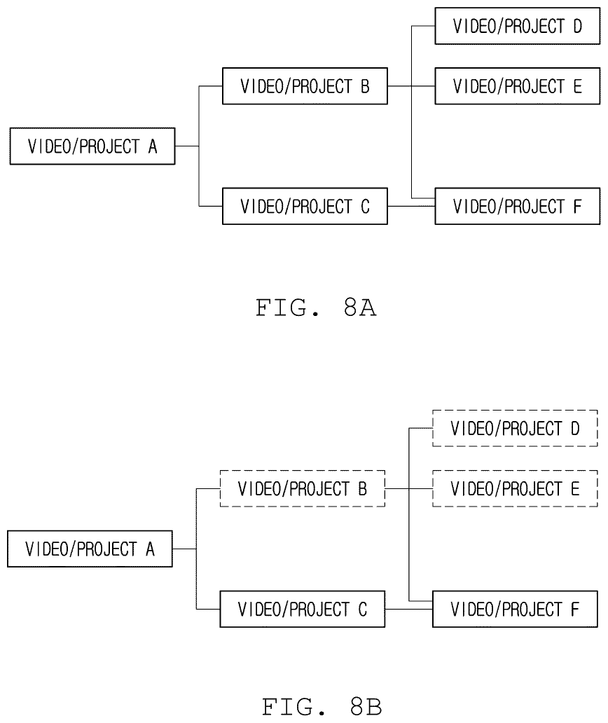

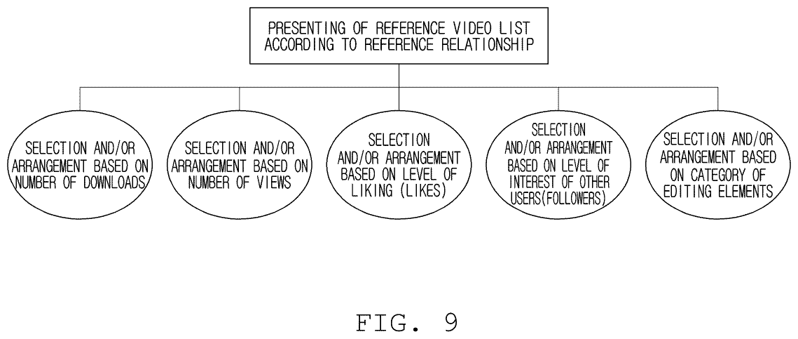

FIGS. 8a and 8b are diagrams illustrating examples in which a reference video is output while content images are structured and managed according to a reference relationship.

As described above, reference relationship information may have data obtained by structuring reference relationships with respect to a plurality of videos. For example, as shown in FIGS. 8a and 8b, the data structure according to the reference relationship may be configured such that the videos/projects B to F that directly or indirectly refer to the reference video designate reference project A (video/project A) as a root node and designate the videos/projects B to F as intermediate nodes connected to the root node. For convenience of description, the “video/project” expressed in FIGS. 8a and 8b is referred to as a video or a reference video. For direct reference and indirect reference, taking video F among the intermediate nodes as an example, video F directly refers to the editing elements of videos B and C, and thus video F and videos B and C have a direct reference relationship. In addition, video A, which is directly referred to by videos B and C, and video F may have an indirect reference relationship.

The reference relationship may include not only direct line reference relationships such as videos A, B, C, and F, but also collateral line reference relationships such as videos D and E.

The application may arrange the videos belonging to a reference video list on the screen of the user device 101 according to the reference relationship based on the data of the server 108 in which the reference relationship is structured. The application may arrange thumbnails to be similar to the tree structure of the reference video list and display it on the user device 101. In addition, the application may arbitrarily arrange thumbnails in the reference video list, provide information related to a reference relationship in association with the thumbnails, or may separately provide a reference relationship structure in a predetermined area of the device screen. In the example of FIG. 8a, the application may express a reference relationship to indicate that video A is a reference video that was first created or edited, and videos B and C are reference videos that refer to video A. As illustrated in FIG. 8b, when a user selects video F from the shared video list, at least the first created preceding video A among a series of preceding videos A to C directly or indirectly referred to in the processing of video F may be output as a reference video. According to a user request or device setting, at least one of preceding videos B and C may be output as a reference video.

By providing the user device 101 with a reference relationship for the video selected by the user, the user may check a path accessible to the video having the reference relationship together with the editing history. Accordingly, it is possible to easily access reference videos having a direct or indirect reference relationship through the video selected by the user. In addition to this, the user may check and apply various expressions of the editing element of interest to the reference videos.

The reference video list may be provided according to a user request as in step S210 or may be directly provided by setting of the application without presenting the list according to step S210. When step S210 is omitted, the reference video list may be provided by grouping a plurality of videos according to the reference relationship and arranging videos having a reference relationship according to a plurality of groups.

Meanwhile, the reference video list may be configured to output at least a part of a plurality of reference videos having a reference relationship with a selected video according to a user request or setting of the application.

As shown in FIG. 8a, the reference video list may include all reference videos having a reference relationship with the video F selected by the user. Specifically, the reference video list may include all direct line reference videos A to C indicated by solid lines and collateral line reference videos D and E. In this case, according to the additional request of the user, the reference video list may be rearranged from reference video A corresponding to the loop node to the reference videos of intermediate nodes of a predetermined level.

As shown in FIG. 8b, the reference video list may include only reference videos having some of the direct line reference relationship indicated by the solid line according to a user request or setting of the application. Accordingly, the reference video list may exclude the collateral line reference relationships indicated by a dotted line and some direct line reference relationships. In FIG. 8b, among a series of preceding videos directly or indirectly referred to in the processing of the selected video F, reference video A generated first is included in the list, and in addition to this, only reference video C having a direct line reference relationship may be arranged in the list. Reference video B having the direct line reference relationship may be excluded based on, for example, preference information according to a user request. The preference information will be described later.

The reference video of the reference video list may be selected based on preference information of a plurality of reference videos. The preference information may be aggregated and managed for each image by the server 108. The preference information may include at least one of a preference of a reference video and a preference of a user who has created the reference content.

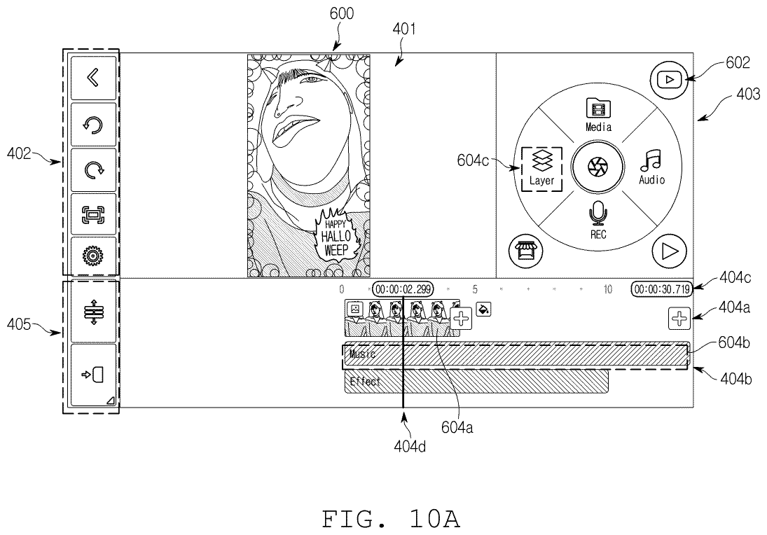

FIG. 9 is a diagram illustrating a criterion for selecting a reference video included in a reference video list.

Referring to FIG. 9 as an example, the preference of the reference video may be the number of downloads, the number of views, and the level of liking (e.g., the number of ‘likes’) of the reference video. The preference of the user may be a user's level of interest (for example, the number of followers) related to the reference video.

As another example, the reference video of the reference video list may be selected based on the category of the editing element of the selected video.

Specifically, the reference video list may be classified and arranged according to categories, to which editing elements of the reference video belong, so as to be easily checked by the user. For example, the server 108 may analyze the editing elements of the reference video and reference project, and classify a reference relationship list into a category in which music editing elements are emphasized, a category in which image editing elements are emphasized, category in which additional sticker editing elements are highlighted. Accordingly, the user device 101 may search for a category of interest and preferentially receive a reference relationship list belonging to the category of interest and a reference video in the list.

Referring back to FIG. 6, when the user device 101 selects a reference video from the reference video list, the server 108 may provide a reference entity including at least one of a reference video or a reference project through the application (S220).

The reference entity may be downloaded to the user device 101 according to a user request, for example. As another example, when the reference entity is a reference video, the reference video may be downloaded or played back through streaming according to the request. In the case of streaming playback, the application may provide a separate window in a predetermined area other than the video display window 401 and the media input window 403 to play back the reference video in the separate window. It is possible to control viewing of at least a part of the reference video by user manipulation so as to be referred to by the user in editing of their own video.

The reference project may include a reference editing element applied to the reference video. The reference editing element may have substantially the same meaning as the above-mentioned editing element, except that it is an editing element of a reference project.

Next, the user may edit the user video using the reference entity including at least one of the reference video or the reference project (S225).

FIGS. 10A to 10D are diagrams illustrating a process of editing user content by a content editing method according to an embodiment of the present disclosure. FIGS. 10A to 10D show an example in which a reference project of a reference video acquired through another user video 566 is directly loaded into the video display window 401 and the media input window 403, and the user inserts the user's video, media objects and additional effects based on the reference project.

As shown in FIG. 10a, the reference video 600 selected by the user is displayed in the video display window 401, and editing elements of the reference project may be checked through the media input window 403 and the clip editing UI 500. That is, the editing elements of the reference project may be provided on an editing element for editing the user video.

The clip display window 404 may provide clip lines 404a and 404b for each media object of the reference video 600. For example, a clip related to an original image or video of a person shown in 600 illustrated in FIG. 10a may be disposed in the main clip line 404a. In addition, information related to the distortion effect of the person in the reference video 600 may be displayed as information related to the additional effect in the main clip line 404a, but is not limited thereto. As another example, the information may be implemented in a separate clip line or other form in the media input window 403. Clips related to music, sub-images, text, sound, stickers, and icons included in the reference video 600 may be represented by corresponding sub-clip lines 404b.

When at least one clip 404a or 404b included in the clip display window 404 is selected, clip editing menus 501, 502, . . . 514 may be provided in an area where the media input window 403 exists. At this time, the clip editing menus 501, 502, . . . 514 may be provided adaptively according to the structure of the editing UI for each clip type. A detailed description related to this will be omitted.

As shown in FIG. 10b, when the user selects the main clip line 404a corresponding to the human face of the reference editing element in the clip display window 404, the user device 101 running the application may receive user input for the selected editable element. The user device 101 may display a clip selector 606 in response to reception. Also, the user device 101 may present an editable UI for a corresponding clip in the media input window 403.

Subsequently, the user device 101 may provide a user request for insertion activation to the media input window 403 through an interface 516. For example, when the user selects the request for insertion activation, the user device 101 may activate the insertion request for replacing the selected human face.

Specifically, referring to FIG. 10b, the interface of the request for insertion activation is shown as Replace 516 in the media input window 403, and the user may activate replacement editing of the reference video 600 by selecting Replace 516. A soft key associated with an activation request may clearly indicate to the user that the corresponding media object is editable. Also, the soft key may activate presentation of candidate items related to alternative insertion elements when there are a plurality of insertion elements to be replaced.

As shown in FIG. 10c, the user device 101 may present a plurality of candidate items insertable into an editable element in response to the request for insertion activation, and may receive a candidate item 608 selected by user input.

In the example of FIG. 10c, a plurality of images to replace a human face selected as an editable element are presented as a candidate item list 517. An object type button 518 may be provided so that the candidate item list is presented for each media object type. If the user wants to select a photo as an insertion element in addition to the video, the user may check the candidate item of the photo by touching the photo interface in the object type button 518. In the case of allowable categories, candidate items may be presented for each media object, or categories of various concepts in which media objects are combined may be presented as candidate items.

As shown in FIG. 10d, the user device 101 may edit the user video 600a based on the reference video 600 by determining the selected item as an insertion element and inserting it into the reference video 600.

The example of FIG. 10d will be described in detail. The user device 101 may replace and edit the existing human face displayed in the clip display window 404 in the reference video 600 with the selected image based on another human face image selected by the user. A distortion effect applied to an existing human face may be applied to an image 608 desired by a user, and the user video 600a may be provided in the video display window 401. An edited image 610 in which the user image and the distortion effect are combined may be generated to be included in the user video 600a.

FIGS. 10A to 10D illustrate using of a replacement editing interface 516 such as Replace in user video editing, but user video editing uses various functions provided to the media input window 403 and the clip editing UI 500 to apply the editing elements of the reference project suitable for the user video.

Next, the user device 101 uploads the edited user video according to the user request, and the server 108 may update reference relationship information based on the entity of the uploaded user video (S230).

For example, the user device 101 may recognize completion of editing of the user video through the export function or project save mentioned in FIG. 3 and upload the edited user video through the shared video menus 566 and 568 according to the user request. The server 108 may update information related to the reference relationship shown in FIGS. 8a and 8b by checking the reference project, the reference video, and the reflection of editing elements of the reference video used when editing the user video.

The disclosure according to FIG. 6 relates to an example of downloading the reference project of the reference video provided from a content sharing menu and editing the user video in the downloaded reference project.

As another example, when editing the user video in a new or existing project created by the user request, the user device 101 may provide, for example, a soft key for obtaining a reference video in a predetermined area of the editing user interface providing the project. By user input through the soft key, the user may obtain a reference entity including a reference video and a reference project shown in FIG. 6 through the user device 101. The obtained reference entity, in particular, an editing element related to the reference project, is provided in the clip display window 404, for example, and may be be loaded adjacent to the editing element of the user. As another example, editing elements of the reference project may be loaded while at least partially overlapping editing elements of a video being edited. For example, the editing elements of the reference project, such as video frames, voices, audio, effects, image frames, text, overlapping layers, etc., may be provided on the video being edited in the video display window 404 and the clip display window 404. An editing element added by the user may exist in the video being edited, and in this case, the added editing element and the obtained editing element may be displayed together.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs) , general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A content editing method using shared content, performed by a computing device including at least one processor, the content editing method comprising:
presenting at least one reference content having a reference relationship with content;
in response to user selection of the reference content, providing a reference entity including at least one of the reference content or a reference project including a reference editing element applied to the selected reference content; and
editing user content using the reference entity.

2. The content editing method of claim 1, wherein the reference relationship is a content history relationship established based on a series of preceding content directly or indirectly referred to in processing of the selected content and a series of succeeding content directly or indirectly referring to the selected content, and the reference relationship is managed by structuring an association between the selected content and the series of preceding and succeeding content.

3. The content editing method of claim 1, wherein the editing the user content comprises providing an editing element of the reference project on an editing element for editing of the user content, when the reference project is used.

4. The content editing method of claim 3, wherein the reference editing element comprises at least one of a media object constituting the reference content or an editing tool configured to edit the reference content.

5. The content editing method of claim 1, wherein the editing the user content comprises performing control to display the reference content in a predetermined area of an editing application processing the user content and view at least a part of the reference content by user manipulation, when the reference content is used.

6. The content editing method of claim 1, wherein the presenting the reference content comprises outputting some of a plurality of reference content having a reference relationship with the content according to a user request or setting of the computing device.

7. The content editing method of claim 6, wherein the output reference content comprises at least firstly created preceding content of the series of preceding content directly or indirectly referred to in processing of the content.

8. The content editing method of claim 6, wherein the output reference content is selected based on preference information of the plurality of reference content, and the preference information comprises at least one of preference of the reference content or preference of a user who created the reference content.

9. The content editing method of claim 6, wherein the output reference content is selected based on a category of the editing element.

10. The content editing method of claim 1, wherein the content is selected by user input from a shared content list provided by an editing application running in the computing device or an external service device connected to the computing device.

11. The content editing method of claim 1,
wherein the reference relationship is stored and managed by reference relationship information, and
wherein the method further comprises:
after the editing of the user content,
uploading the user content; and
updating the reference relationship information based on an entity of the user content.

12. A computing device for editing content using shared content, the computing device comprising:
a communication module; and
a processor configured to perform transmission and reception with the communication module and to control the computing device,
wherein the processor is configured to:
present at least one reference content having a reference relationship with content;
in response to user selection of the reference content, provide a reference entity including at least one of the reference content or a reference project including a reference editing element applied to the selected reference content; and
edit user content using the reference entity.
